(19) United States
(12) Patent Application Publication
(10) Pub. No.: US 2026/0040060 A1
(43) Pub. Date: Feb. 5, 2026

(54) WIRELESS COMMUNICATION SYSTEM

(71) Applicant: KONINKLIJKE PHILIPS N.V., EINDHOVEN (NL)

(72) Inventors: Oscar Garcia Morchon, Eindhoven (NL); Noureddine Sabah, Eindhoven (NL)

(21) Appl. No.: 19/099,791

(22) PCT Filed: Aug. 2, 2023
(86) PCT No.: PCT/EP2023/071425

§ 371 Date: Jan. 30, 2025

(30) Foreign Application Priority Data
Aug. 2, 2023 (EP) 22188978.5

(51) Int. Cl. H04W 12/033; H04L 1/00; H04L 5/00; H04W 12/65

(52) U.S. Cl. CPC H04W 12/033; H04L 1/004; H04L 5/0044; H04W 12/65

(57) ABSTRACT

This invention relates to a method for exchanging a payload in a secure manner, the method comprising an initiator generating an initiation message, the initiator performing a first modification of one or more physical characteristic of the initiation message, and the initiator transmitting the modified initiation message to a responder, the responder receiving the modified initiation message from the initiator, the responder measuring one or more incoming physical characteristic of the received modified initiation message, the responder creating a response message to be sent back to the initiator, the responder modifying one or more physical characteristic of the response message on the basis of a second modification including a combination of the measured incoming physical characteristic and the payload, transmitting the modified response message to the initiator, the initiator receiving the modified response message, the initiator modifying the received modified response message on the basis of the first modification, and extracting the payload from the received modified response message.

### FIELD OF THE INVENTION

The invention relates to a method for communicating a message in a secure manner and for corresponding apparatuses and systems. This invention is particularly relevant for wired and wireless communication systems, for example cellular systems such as 5G or 6G, or Wifi systems, or adhoc systems, satellite communication systems, or optic fiber communication systems.

### BACKGROUND OF THE INVENTION

In communication networks, messages are exchanged between the different stations, such as mobile stations (or User Equipment (UEs) in the example of 5G), base station (gNB in a 5G system), repeater. To ensure authenticity of the different stations and/or prevent others to eavesdrop on the exchanged message(s), it is known to use encryption, such as using a shared encryption key or some authenticity signature.

However, sharing the encryption key needs to be done in a secure manner as well in order not to jeopardize the security of the later communications. In some systems, the keys are stored in advance in each device to be able to skip this step. However, this limits the possibility of dynamic keys which are more robust and reduce the risk of corrupting a whole system. Also, this can raise issues with privacy. Thus, it is preferred in many systems, to share keys dynamically, i.e. keys that are generated for the current communication. Since no encryption secret has been shared between the parties, distributing the key is a highly critical step.

A key exchange method may indeed present a number of problems such as the reliability of the exchanged key (whether it could have been intercepted, or whether it is strong enough due to limited length), or the lack of authentication between initiator and responder. Further, it is required to find a particular method that is compatible with a communication system such as 5G. Since 5G lacks protection of initial messages and L1 and L2 signalling messages, 5G is prone to certain attacks, e.g.:
Sparrow attack in which UEs that have not registered with the network are capable of communicating with each other via the base station;
Unprotected exchange of certain fields in initial messages, e.g., priority access;
Unprotected exchange of low layer signaling messages allowing for attacks such as IP spoofing and SUPI catching;
Unprotected RRC Connection Setup, e.g., Inability to share sensitive information with the network nor the base station.

Moreover, wireless systems such as cellular networks may support a variety of low power devices such as IoT tags, powerful mobile user equipment devices (UEs) (e.g., smartphones, V2X-connected vehicles, and so on), or infrastructure devices (e.g., stationary and/or mobile gNBs, V2X roadside units, and so on) having various capabilities in terms of processing power, energy consumption, memory space, etc. Therefore, a key exchange method needs to also consider such limitations. For instance, while having the same security requirements as other devices (e.g., authentication, data protection, privacy protection, etc), Ambient (or passive) IoT are tiny computing devices that rely on ambient radio waves' energy harvesting to power themselves. Hence, it is required to find a method that can be supported by such devices to fulfill their security requirements.

### SUMMARY OF THE INVENTION

It is an object of the present invention to alleviate the above-identified problems.

It is another object of the present invention to provide a protocol to exchange a message, such as data, e.g., the network identity assigned to a device, an encryption key or other encryption/authentication material between two entities of a network in a secure manner.

It is another object of the present invention to provide a communication system that can exchange a payload in a secure manner without the need of a prior exchange of encryption material or of pre-shared stored keys.

It is still another object of the present invention to provide a device with the means to securely send a payload, such as an encryption key or a secret to be used in later phases of the communication, in a secure manner at the establishment of a connection.

These objects are achieved by the methods, the communication apparatus, the computer program product and the system defined in the appended claims.

Thus, in accordance with a first aspect of the invention, it is proposed a method for transmitting a payload in a secure manner,
the method comprising a responder receiving an initiation message from an initiator,
the responder measuring one or more incoming physical characteristic of the received initiation message, creating a response message to be sent back to the initiator,
modifying one or more physical characteristic of the response message on the basis of a combination of the measured incoming physical characteristic and the payload,
transmitting the modified response message to the initiator.

Thus, the invention as defined in the first aspect enables to encapsulate a bitstream determined by a responder device, such as a payload, by means of a physical characteristic of a received message from an initiator. This set of physical characteristics is thus linked to the initiator and the path link that the received message propagated through. It then enables an initiator device to decapsulate it in a secure manner. The bitstream might be a key, and then this key (or a derived value from it) can be used for security purposes, e.g., encryption in later operational phase of the communication. Since the bitstream is fully determined by the responder, the bitstream might be a key including some redundant information (e.g., error correction) to increase the reliability of the scheme.

In a first variant of the first aspect, the combination of measured incoming physical signal characteristic and the payload includes
encoding the payload as a codeword including a set of bits, and mapping the codeword set of bits into a mapped set of physical characteristic values,
generating the combination as a difference between the measured incoming physical signal characteristic and the mapped set of physical characteristic values.

In a second variant of the first aspect that can be combined with the first variant, the payload is an encryption key to be used by the initiator for secure communication with the responder.

In a third variant of the first aspect that can be combined with the first variant, the payload can be a radio network identifier (e.g. RNTI), a preamble (e.g. RACH preamble), or any data to be used by the initiator and responder, e.g., for communication.

In a fourth variant of the first aspect that can be combined with the first and/or second and/or third variants, the physical characteristic of the initiation message and physical characteristic of the response message comprises one or more of the following: a phase, or a phase difference for each carrier relative to a reference carrier, or a gain, or a gain difference for each carrier relative to a reference carrier, or a polarization for each beam relative to a reference beam, or modulation symbols, or a gain value applied to each beam, or an OAM mode, or a phase pattern in an OAM mode respectively.

In a fifth variant that can be combined with the other variants, the payload comprises a useful payload and one or more of the following: one or more set of parity check bits, one or more set of Cyclic Redundancy Check bits or a reliability bit-string known by the initiator.

In a sixth variant that can be combined with any of the previous variants, th payload is obtained by applying a Forward Error Correction algorithm to a set of information bits.

In a seventh variant of the first aspect that can be combined with any of the previous variants, the payload is obtained by interleaving a set of information bits with a corresponding reliability bit-string known by the initiator.

In an eighth variant of the first aspect that can be combined with the previous variants, the payload comprises an encapsulated key used to protect data encoded (e.g., QAM encoded) in the signal carriers, e.g. using the encapsulated key to encrypt the data.

In a ninth variant of the first aspect that can be combined with the eighth variant, the encapsulated key is concatenated or interleaved with the encrypted or encapsulated data.

In accordance with a second aspect of the invention, it is proposed a method for exchanging a payload in a secure manner,
the method comprising
an initiator generating an initiation message, the initiator performing a first modification of one or more physical characteristic of the initiation message, and the initiator transmitting the modified initiation message to a responder,
the responder receiving the modified initiation message from the initiator,
the responder measuring one or more incoming physical characteristic of the received modified initiation message,
the responder creating a response message to be sent back to the initiator,
the responder modifying one or more physical characteristic of the response message on the basis of a second modification including a combination of the measured incoming physical characteristic and the payload,
transmitting the modified response message to the initiator,
the initiator receiving the modified response message,
the initiator modifying the received modified response message on the basis of the first modification, and extracting the payload from the received modified response message.

In a first variant of the second aspect, the combination of measured incoming physical signal characteristic and the payload includes
encoding the payload as a codeword including a set of bits, and mapping the codeword set of bits into a mapped set of physical characteristic values,
generating the combination as a difference between the mapped set of physical characteristic values and the measured incoming physical signal characteristic values.

In a second variant of the second aspect that can be combined with the first variant, the payload is an encryption key to be used by the initiator for secure communication with the responder.

In a third variant of the second aspect that can be combined with the first variant, the payload can be a radio network identifier (e.g. RNTI), a preamble (e.g. RACH preamble), or any data to be used by the initiator and the responder, e.g., for communication.

In a fourth variant of the second aspect that can be combined with any of the previous variants, the first modification is a random change of one or more physical characteristic of the initiation message.

In a fifth variant of the second aspect that can be combined with any of the previous variants, the physical characteristic of the initiation message and physical characteristic of the response message comprises one or more of the following: a phase, or a phase difference for each carrier relative to a reference carrier, or a gain, or a gain difference for each carrier relative to a reference carrier, or a polarization for each beam relative to a reference beam, or modulation symbols, or a gain value applied to each beam, or an OAM mode, or a phase pattern in an OAM mode respectively.

In a sixth variant of the second aspect that can be combined with any of the previous variants, the payload comprises a useful payload and one or more of the following: one or more set of parity check bits, one or more set of Cyclic Redundancy Check bits or a reliability bit-string known by the initiator.

In a seventh variant of the second aspect that can be combined with any of the previous variants, the payload is obtained by applying a Forward Error Correction algorithm to a set of information bits.

In an eighth variant of the second aspect that can be combined with any of the previous variants, the payload is obtained by interleaving a set of information bits with a corresponding reliability bit-string known by the initiator.

In a ninth variant of the second aspect that can be combined with any of the previous variants, the payload comprises an encapsulated key used to protect data encoded (e.g., QAM encoded) in the signal carriers, e.g. using the encapsulated key to encrypt the data.

In a tenth variant of the second aspect that can be combined with the ninth variant of the second aspect the encapsulated key is concatenated or interleaved with the encrypted and/or encapsulated data.

In accordance with a third aspect of the invention, it is proposed a computer program product comprising code means for producing the steps of the first or second aspects of the invention, possibly including any of their respective variants, when run on a computer device.

In accordance with a fourth aspect of the invention, it is proposed a method for receiving a payload in a secure manner,
the method comprising an initiator generating an initiation message, the initiator performing a first modification of one or more physical characteristic of the initiation message, and the initiator transmitting the modified initiation message to a responder,
the initiator receiving a response message, modifying the response message on the basis of the first modification, and extracting the payload from the modified response message.

In a first variant of the fourth aspect of the invention, the payload corresponding to an encryption key, and the initiator using the encryption key to decrypt additional data transmitted in the received message.

Any of the variants of the first or second aspects of the invention may be combined with this fourth aspect of the invention or its first variant as well.

The following variants can be combined with any of the previous variants of the introduced aspects. First, the initiator(s) and responder(s) may be End devices and/or Relays (e.g., UE-to-UE Relay(s) or UE-to-Network Relay(s)) communicating by means of sidelink communication links. Further, the initiator may be a UE (e.g., V2X UE, ProSe UE, etc) or an access device (e.g., gNB), and the responder is a passive/ambient IoT device. Further, a first responder may play the role of a second initiator that exchanges a payload with a second responder, thereby combining both initiator and responder roles and implementing each role functionality in a separate communication link. Additionally, an established secret key may be used as a fallback option when devices (End-UEs and/or UE-to-UE Relays) are not provisioned with discovery security materials and/or have expired long-term credentials.

Further, an established secret key may be combined with established or provisioned security materials to derive a cryptographic key or a MIC or a scrambling sequence or an encryption sequence by means of a cryptographic function wherein the cryptographic function may be a key derivation function, or an encryption algorithm or an integrity algorithm.

In accordance with a fifth aspect of the invention, a communication apparatus for transmitting a payload in a secure manner,
the communication apparatus comprising a receiver,
a transmitter,
a controller, and
a memory for storing instructions for causing
the receiver to receive an initiation message from an initiator,
the controller to measure one or more incoming physical characteristic of the received initiation message,
the controller to create a response message to be sent back to the initiator,
the controller to modify one or more physical characteristic of the response message on the basis of a combination of the measured incoming physical characteristic and the payload,
the transmitter to transmit the modified response message to the initiator.

In accordance with a sixth aspect of the invention, it is proposed a communication apparatus for receiving a payload in a secure manner,
the communication apparatus comprising a controller, a transmitter, a receiver and a memory comprising instructions for causing:
   the controller to generate an initiation message, and to perform a first modification of one or more physical characteristic of the initiation message,
   the transmitter to transmit the modified initiation message to a responder, and the receiver to receive a modified response message,
   the controller to modify the received modified response message on the basis of the first modification, and extracting the payload from the received modified response message.

In accordance with a seventh aspect of the invention, it is proposed a communication system for exchanging a payload in a secure manner,
the communication system comprising an initiator and a responder,
the initiator comprising an initiator controller, an initiator transmitter, an initiator receiver and an initiator memory comprising instructions for causing:
   the initiator controller to generate an initiation message, and to perform a first modification of one or more physical characteristic of the initiation message,
   the initiator transmitter to transmit the modified initiation message to the responder,
and the initiator receiver to receive a modified response message,
   the initiator controller to modify the received modified response message on the basis of the first modification, and extracting the payload from the received modified response message,
the responder comprising a responder receiver, a responder transmitter, a responder controller and a responder memory comprising instruction for causing
   the responder receiving the modified initiation message from the initiator,
   the responder controller to measure one or more incoming physical characteristics of the received modified initiation message,
   the responder controller to modify one or more physical characteristics of the response message on the basis of a second modification including a combination of the measured incoming physical characteristic and the payload creating a modified response message,
   the responder transmitter to transmit the modified response message to the initiator.

It is noted that the above apparatus may be implemented based on discrete hardware circuitries with discrete hardware components, integrated chips, or arrangements of chip modules, or based on signal processing devices or chips controlled by software routines or programs stored in memories, written on a computer readable media, or downloaded from a network, such as the Internet.

It shall be understood that the method of claim 1, the method of claim 8, the method of claim 17 the computer program product of claim 19, the communication apparatus of claim 20, the communication apparatus of claim 21, and the communication system of claim 22 may have similar and/or identical preferred embodiments, in particular, as defined in the dependent claims.

It shall be understood that a preferred embodiment of the invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 is a block diagram representing a network implementing embodiments of the invention,

FIG. 2 is a block diagram representing a mobile station operating in accordance with the embodiments of the invention,

FIG. 3 is a block diagram representing a base station operating in accordance with the embodiments of the invention,

FIG. 4 is a flow chart representing the communication in accordance with a first embodiment of the invention,

FIG. 5 is a flow chart representing the communication in accordance with an embodiment of the invention,

FIG. 6 is a flow chart representing the communication in accordance with an embodiment of the invention,

FIG. 7 is a flow chart representing the communication in accordance with an embodiment of the invention,

FIG. 8 is a block diagram representing the operation in communication units at the physical layer in accordance with an implementation of the invention,

FIG. 9 is diagram representing the coding/decoding process in accordance with an implementation of the invention,

FIG. 10 is a flow chart representing the communication in accordance with a second embodiment of the invention adapted to a 5G network.

FIG. 11 is block diagram schematically representing a network and devices involved in Sidelink communications implementing embodiments of the invention,

FIG. 12 is a flow chart representing the communication in accordance with a third embodiment of the invention adapted to 5G Sidelink communication,

FIG. 13 is a flow chart representing the communication in accordance with a variant of the third embodiment of the invention adapted to 5G Sidelink communication.

### DETAILED DESCRIPTION OF EMBODIMENTS

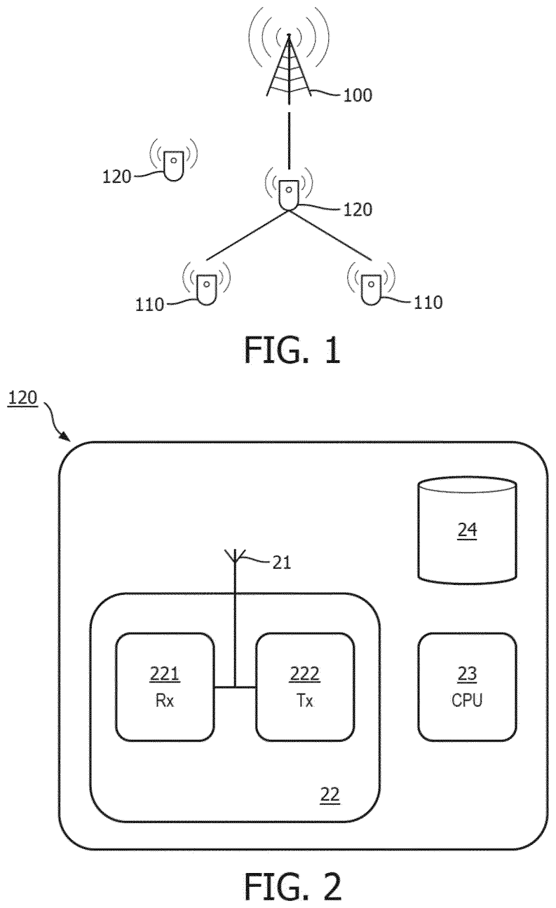

Embodiments of the present invention are now described with reference to the drawings. As mentioned earlier, the embodiments of the invention may be implemented in different types of networks and, in particular, in wireless networks, or in optical fiber networks or satellite-based communication networks or visible light communication. In a specific example represented in FIG. 1, a cellular network is depicted. Such a cellular network may be a 3g, 4g or 5g network or even a Wifi network. Each cell 10 is served by a base station 100, e.g. a gNB in 5G. A plurality of secondary stations are located in the vicinity of the cell 10 and of the base station 100. At least some of these secondary stations 120 can communicate directly with the base station 100. Further, some of the secondary stations can act as relay stations as they include functionalities to relay 9 communication between a base station 100 and another secondary station 110. This relay function for example helps to extend the coverage of a cell 10 to an out-of-coverage (OoC) secondary station 110. The relay station may be a mobile station (e.g. a UE) or could be a different type of device. As 4G and 5G networks include the possibility of relaying by UEs including the Sidelink functionalities, the relay station and the secondary station 110 of FIG. 1 may be in this example UEs that include Sidelink functionalities.

### Embodiment 1: Physical Layer Key Encapsulation Scheme

In accordance with this first embodiment, and with reference to FIG. 2, the mobile station 120 typically includes an antenna 21 or an antenna array (e.g. for a MIMO compatible wireless terminal). This antenna 21 is coupled to a communication unit 22 including a receiver 221 and a transmitter 222. The communication unit 22 may be compatible with 3GPP standards, such as UMTS, LTE or NR, and operates accordingly depending on the current connection. In an embodiment, a controller 23 such as a microprocessor is included to control the communication unit and its receiver 221 and transmitter 222. It is to be noted that the controller 23 may be dedicated to the communication unit 22 and even included within it. The controller 23 may also operate other systems and not only be dedicated for the communication unit 22. Typically, some part or all of the process involved may be operating by a software stored in a memory 24 (such as a ROM or an EEPROM) of the mobile station 120. However, it is also possible that the whole invention is included in hardware in the components.

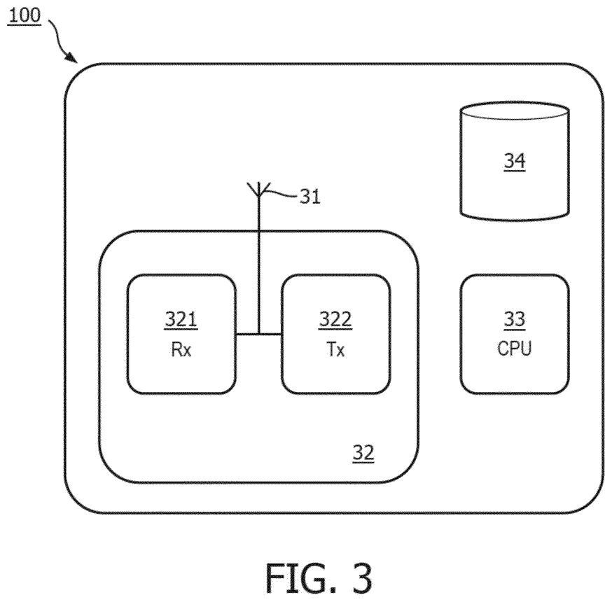

Similarly, as can be seen on FIG. 3, the base station 100 typically includes an antenna 31 or an antenna array (e.g. for a MIMO compatible wireless terminal). This antenna 31 is coupled to a communication unit 32 including a receiver 321 and a transmitter 322. The communication unit 32 may be compatible with 3GPP standards, such as UMTS, LTE or NR, and operates accordingly depending on the current connection. In an embodiment, a controller 33 such as a microprocessor is included to control the communication unit and its receiver 321 and transmitter 322. It is to be noted that the controller 33 may be dedicated to the communication unit 32 and even included within it. The controller 33 may also operate other systems and not only be dedicated for the communication unit 32. Typically, some part or all of the process involved may be operating by a software stored in a memory 34 (such as a ROM or an EEPROM) of the base station 100. However, it is also possible that the whole invention is included in hardware in the components.

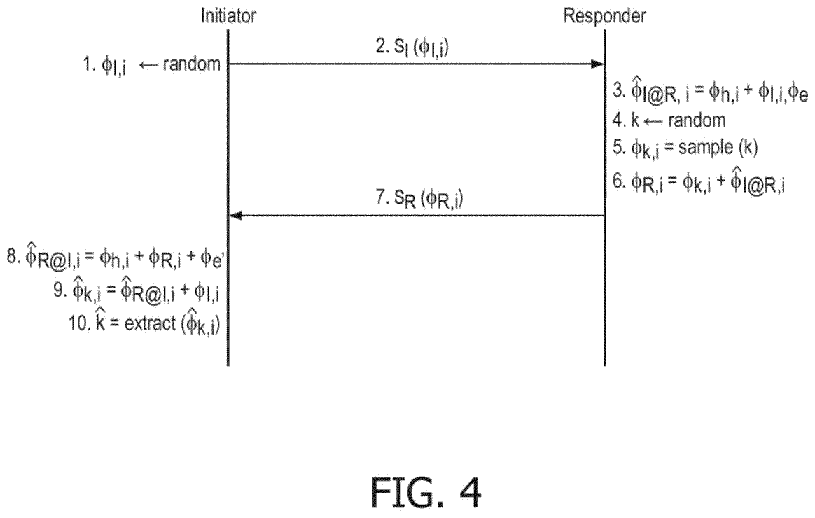

In accordance with the first embodiment of the invention, the mobile station 120 (the initiator) desiring to initiate a connection starts by generating a request message. As can be seen on FIG. 4, a physical characteristic of the request message is modified, possibly randomly. In this example at step 1, the Initiator may assign, e.g., random phases to the sub-carriers carrying the request message to form a modified request message S_{I}. Then, at step 2, the modified request message S_{I} is transmitted to the Responder for example a base station 100. For the sake of simplicity, only the phase θ_{I,I} of the i-th sub-carrier is shown in FIG. 4. However, the modification may be performed on all or a subset of the carriers.

These random phases may be applicable to, e.g., the carriers in an orthogonal frequency-division multiplexing (OFDM) system. The usage of randomized physical features in this and other embodiments may also be applicable to other physical features in an OFDM system, e.g., related to the amplitude of the carriers. The physical characteristic of the message that is modified may also be of a different nature if a different type of digital transmission system or modulation is applied, for instance, in the case of a digital transmission system relying on Orbital Angular Momentum (OAM), the physical feature may refer to the OAM mode or an initial phase of the OAM mode. For instance, in the case of a system relying on a digital transmission system based on Polarization Division Multiplexing, the physical feature may refer to the phase shift or the sense of polarization. For instance, in spatial modulation systems, the physical feature may be the phase shift randomizing constellation mapping.

At Step 3, the Responder receives S₁ and its controller estimates the equivalent channel phase ϕ_{I@R,i}, which is subject to noise due to channel response and phase estimation error such that ϕ_{I@R,I}, Iₕ, i+ϕ_{I,i}+ϕ_{ε,i}. Thus, in addition to the first modification of phase generated by the initiator, further perturbations that are related to the particular propagation path between the Initiator and the Responder occur.

Then, at Step 4: The Responder generates a message, for example for the sake of later secure communication, a random key K that will be used between the Initiator and the Responder. Instead of a key, it could be another private data, such as an authentication, or a message K that is dedicated to the Initiator only.

At step 5, the secret message K is encoded (or transformed) as a set of phases on the different carriers. For example, the message K can be mapped into secret phases as follows:

Let m be the number of bits to encode per phase, and K=[K_{seq,1}, K_{seq,2} . . . K_{seq,N}] the randomly generated secret key K, such that K_{seq,i} are m-long bit sequences. Let F be the mapping function, also known to the Initiator:

$$F ( {K}_{seq , i} ) = D ( {K}_{seq , i} ) \frac{π}{{2}^{m - 1}} \qquad ( E1 )$$

where D(s) may be the decimal equivalent of a Reflected Binary Code (RBS) s as will be detailed later. As such, the Responder maps each of the K_{seq,i} into its respective phases.

At Step 6: The secret phases ϕ_{K,i} are encapsulated using the channel phase estimations from step 3 as follows: ϕ_{R,i}=ϕ_{K,i}−ϕ_{I@R,i}. The encapsulation can be seen as a form of encryption, whereby only a party, in the same channel, with knowledge of ϕ_{I,I} can extract the correct key K, as the “encryption” is linked to the propagation path of the message between Initiator and Responder.

In step 7, the Responder transmits S_{R} which carries within its sub-carriers' phases the encapsulated secret message.

In step 8, similar to step 3, the Initiator estimates the equivalent channel phase from S_{R} which is given as: ϕ_{R@I,i}=ϕ_{h,i}+ϕ_{R,i}+ϕ_{ε′,i}.

In step 9, ϕ_{I,i} is added to ϕ_{R@I,i} thereby unmasking ϕ_{K,i}. Indeed, as can be seen from the following by adding the initial random set of physical characteristics (here phases), it allows the Initiator to obtain the phases ϕ_{K,I} with some residual errors.

In particular, it can be shown that:

$$\begin{matrix}{ϕ}_{R @ I , i} = {ϕ}_{h , i} + {ϕ}_{R , i} + {ϕ}_{{ε}^{′} , i} \\ = {ϕ}_{h , i} + {ϕ}_{K , i} - {ϕ}_{I @ R , i} + {ϕ}_{{ε}^{′} , i} \\ ( Substituting {ϕ}_{R , i} by its equivalent in step 6 ) \\ = {ϕ}_{h} , i + {ϕ}_{K , i} - ( {ϕ}_{h} , i + {ϕ}_{I , i} - {ϕ}_{ε , i} ) + {ϕ}_{{ε}^{′} , i} \\ ( Substituting {ϕ}_{I @ R , i} by its step 3 equivalent ) \\ = {ϕ}_{K , i} - {ϕ}_{I , i} - {ϕ}_{ε , i} + {ϕ}_{{ε}^{′} , i} \\ {ϕ}_{R @ I , i} + {θ}_{I , i} = {ϕ}_{K , i} - {ϕ}_{I} , i - {ϕ}_{ε , i} + {ϕ}_{{ε}^{′} , i} + {ϕ}_{I} , i ( Adding {ϕ}_{I , i} to unmask {ϕ}_{K , i} ) \\ = {ϕ}_{K , i} - ϕε , i + {ϕε}^{′} , i\end{matrix}$$

Then, at step 10: The Initiator may decode the phases ϕ′_{K,i} to retrieve the bit sequences they each map to. Ideally, these bit sequences would be equivalent to K_{seq,i}, eventually reconstructing the secret message K. The extraction process can be described as follows:
let m be the agreed upon number of bits to encode per phase, and ϕ′_{K,i}=ϕ_{K,i}−ϕ_{ε,i}+ϕ_{ε′,i}.

The interval [0, 2π] is divided into 2′ equal sub-intervals, each mapped to a bit sequence following RBC ordering. The j-th sub-interval is defined as

$$[ \frac{π ( 2 j - 1 )}{{2}^{m}} , \frac{π ( 2 j + 1 )}{{2}^{m}} [$$

with 0 [symbol] j [symbol] 2^{m}−1.

Based on which interval ϕ_{K′,i} falls within, the secret bit sequence is retrieved as:

$${F}^{- 1} ( {ϕ}_{K , i}^{′} ) = RBC ( j )$$

If there is no error, F⁻¹(ϕ′_{K,i})=K_{seq,i} assuming that

$$\vert {ϕ}_{ε , i} + {ϕ}_{{ε}^{′} , i} \vert < \frac{2 π}{{2}^{m + 1}} .$$

Hence, by retrieving the bit sequences of all sub-carriers' phases, the Initiator can reconstruct the secret message K.

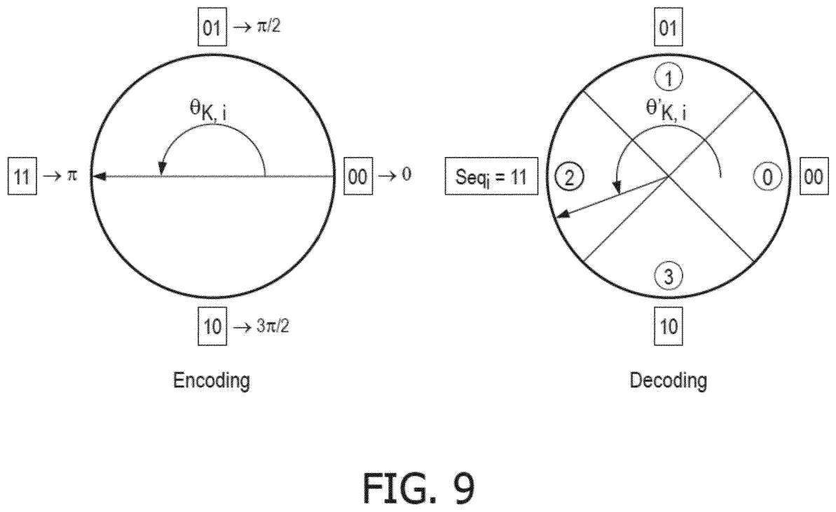

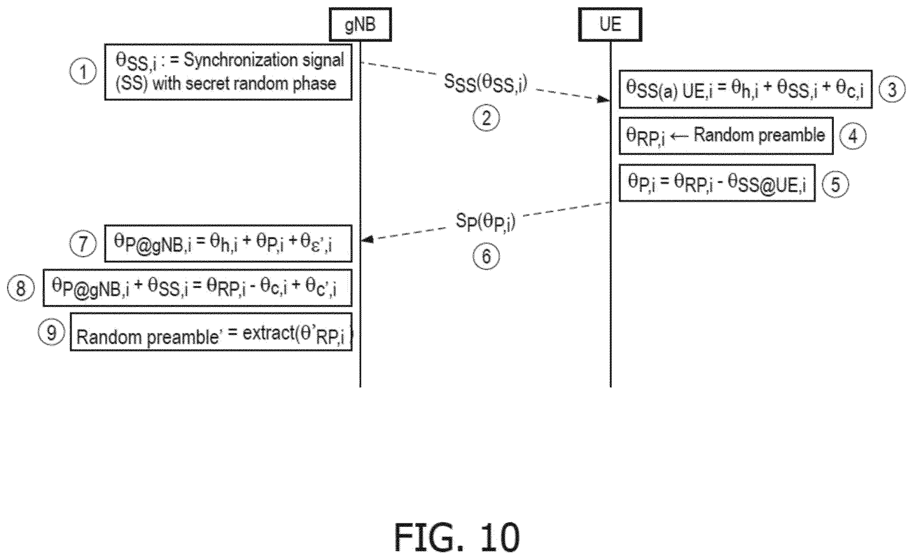

In this embodiment, and other embodiments, the Greek letter ϕ as used in FIGS. 4, 5, 6, and 7, and the Greek letter θ as used in FIGS. 9 and 10, refer to the same physical characteristic of the signal (e.g., phase). This notation may be applicable to represent other physical features.

An example of the encoding and decoding of a secret bit sequence is represented on FIG. 9. The following is an example of how a secret key bit sequence K_{seq,i} can be mapped into its respective phase ϕ_{K,i}, then extracted on the receiving end.

On the left side of FIG. 9, for m=2, K_{seq,i}∈{00, 01, 10, 11}, the bit sequences are mapped to phases as follows, F(K_{seq,i}) yields:

$$ℱ ( {K}_{seq , i} ) = \{ \begin{matrix}0 , & {K}_{seq , i} = 00 \\ π / 2 , & {K}_{seq , i} = 01 \\ π , & {K}_{seq , i} = 11 ⟹ {θ}_{K , i} = 2 \frac{π}{{2}^{2 - 1}} = π \\ 3 π / 2 , & {K}_{seq , i} = 10\end{matrix}$$

As such, the bit sequence 11 shown on the left part of FIG. 9 is mapped to π for example. On the right side of FIG. 9, the bit sequences are extracted from secret phases as follows:

$${ℱ}^{- 1} ( {θ}_{K , i}^{′} ) = \{ \begin{matrix}00 , & {θ}_{K , i}^{′} ∈ [ - \frac{π}{4} , \frac{π}{4} [ ⟹ j = 0 \\ 01 , & {θ}_{K , i}^{′} ∈ [ \frac{π}{4} , \frac{3 π}{4} [ ⟹ j = 1 \\ 11 , & {θ}_{K , i}^{′} ∈ [ \frac{3 π}{4} , \frac{5 π}{4} [ ⟹ j = 2 ⟹ {Seq}_{i} = RBC ( 2 ) = 11 \\ 10 , & {θ}_{K , i}^{′} ∈ [ \frac{5 π}{4} , \frac{7 π}{4} [ ⟹ j = 3\end{matrix}$$

As such, θ′_{K,i}≈10π/9, which falls in the 3rd sub-interval (j=2), yields Seqᵢ=11. The extracted bit sequence is equivalent to the intended K_{seq,i} in this case.

In the above embodiment, it is to be noted the following references: The two communicating parties may be using the same channel h that is assumed to remain constant during the handshake or communication establishment process. It is further defined the following:
S_{I}, S_{R}: The signals transmitted by the Initiator and Responder to the other party respectively.
ϕ_{I,i}, ϕ_{R,i}: Phases of the i-th sub-carrier transmitted by the Initiator and Responder respectively; ϕ_{I,i} may be random and unknown to the Responder.
ϕ_{ε*,i} , ϕ_{ε}′, i: Phase estimation errors of the extracted phases from the received signals.
ϕ_{I@R,i}, ϕ_{R@I,i}: The equivalent channel phase estimated upon reception by the Responder and Initiator respectively.
ϕ_{K,i}: Secret phases derived from the randomly generated key K.

It is to be noted in this example that the initiator is the mobile station 120 and the responder is a base station 100. However, this embodiment, like the following embodiments may apply to the case where the initiator is a base station 100 and the responder is a mobile station 120. The embodiments equally apply to the case where the initiator and the responder are the same type of device, e.g. two mobile stations 120 or two base stations 100, or two wireless stations. Further, Initiating medium (e.g. the Bandwidth) and Response medium are in the shown embodiments identical (or reciprocal) (channel h here). However, the invention could be implemented as well for cases where the Response medium is narrower but for e.g. included in the Initiating medium, or at least correlated medium, for example when their respective set of carriers are not too far apart.

Thus, in this first embodiment like in the later embodiments, two parties are involved, Initiator and Responder. These two parties might be, e.g.:
A UE and a base station (or the other way around)
A first UE and a second UE
A base station and a smart repeater (or the other way around)
A first wireless repeater and a second wireless repeater (e.g., two IAB nodes or two satellites)
A WiFi station and a WiFi access point (or the other way around)
A transmitter and a receiver in optical communication link, e.g., over an optic fiber communication link.

The Initiator sends an initial probe message for which a physical characteristic is first modified, which is received by the Responder. The Responder may determine or select a key K or generate a message K, encapsulates K by modifying the physical characteristics on the basis of the estimation result. The responder then sends a reply message with the encapsulated message K.

Eventually, the Initiator receives the reply message, and decapsulates the message by applying the same modification as in the initial phase.

This first embodiment may be complemented with the following variations.

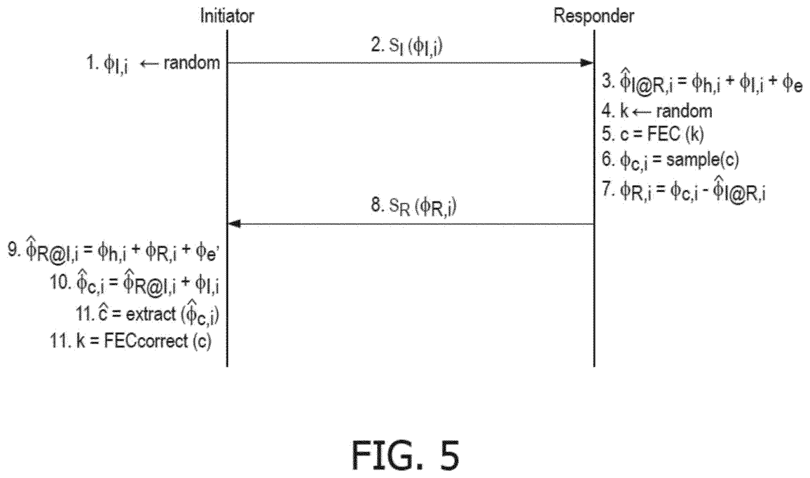

The secret message may be an FEC codeword that is encapsulated. This allows for a more robust transmission and to increase the number of bits m encoded per phase (or other physical characteristic). This variation is shown on FIG. 5. This second embodiment is similar to the first embodiment for the steps 1-4. At step 5, a Forward Error Correction (FEC) algorithm is applied on the randomly generated secret message K to obtain the code-word C.

At step 6, the code-word C is translated into phases ϕ_{C,i} for example following a Gray Code/Reflected Binary Code(RBC) to phase mapping. RBC is an ordering of binary sequences such that two consecutive values differ only in one bit. Hence, by using RBC, the bit error rate is reduced in the decoding process, as only one bit changes between the sequence mapped to an interval j and the ones mapped to intervals j+1 and j−1. Steps 7-11 are similar to steps 6-10 of the first embodiment of FIG. 4. Eventually, at step 12, the received codeword is used to retrieve the secret message K.

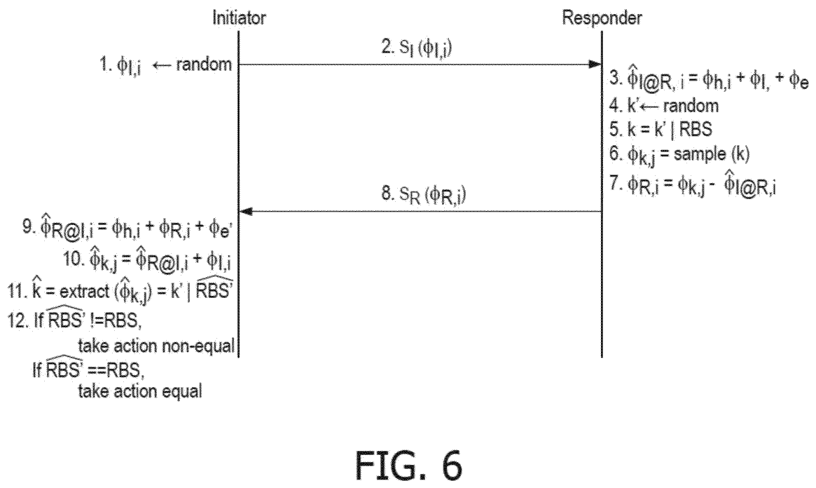

Further or as a variation, it is possible to include a Reliability bitstring and/or CRC in the encoded secret. This third embodiment, shown on FIG. 6, is similar to the first embodiment for the steps 1-4. At step 5, A reliability bit string (RBS), which is also known to the Initiator, is concatenated with the randomly generated secret message K. Alternatively, RBS can be interleaved with K.

Steps 6-10 are similar to steps 5-9 of the first embodiment of FIG. 4.

At step 11, Depending on whether the RBS is concatenated or interleaved with the secret message K, Extract(ϕ′_{K,i}) yields the following:

| | ${\underline{K}}_{seq , i}^{′} = Extract ( {ϕ}_{K , i}^{′} )$ | | |
|---|---|---|---|
| Concatenated | ${K}_{seq , i}^{′}$ | | RBS′ |
| Interleaved | ${K}_{seq , i}^{′}$ | RBS′ | ${K}_{seq , i}^{′} [ a , b ] \vert R B {{S}^{′} [ c , d ]}^{*}$ |

*[a, b] and [c, d] denote the start and end positions of sub-strings from the binary sequences K′_{seq,j} and RBS′ respectively, such that (b − a) + (d − c) equals the number of bits encoded per phase.

At Step 12, regardless of whether RBS is concatenated or interleaved with K, the Initiator can only compare the known RBS to RBS' after having decoded all ϕ′_{K,i}. If RBS≠RBS′, the initiator knows that K is likely to contain flipped bits, otherwise, K may be reliable.

It is to be noted that instead of agreeing on a predefined reliability bitstring, the responder might compute a CRC in Step 5 and the initiator might check the CRC in Step 12. As an alternative to RBS, Cyclic Redundancy Check (CRC) can be employed for error detection in the transmission of the secret key K; CRC is widely used in communication protocols and is integrated in almost every device, in software as in hardware.

In an embodiment variant, at step 5, the randomly generated secret key K can be divided into j equal bit sequences Kᵢ of length l with 0≤i≤j−1. For each Kᵢ, a CRC cᵢ consisting of m parity bits is computed and appended to Kᵢ to form a codeword CWᵢ=[Kᵢ,cᵢ] that is l+m bits long. The j codewords are then concatenated to form K. In total, m*j overhead bits will be added to the secret message K before transmission. In step 11, Since cᵢ bits are interleaved with Kᵢ bit sequences, depending on how many bits are encoded per phase, Extract(ϕ′_{K,i}) yields K′_{seq,i}, c′ᵢ or K′_{seq,i}[a, b]|c′ᵢ[c, d]. In Step 12, as in the RBS scenario, the check for errors in transmission is done after retrieving both the K′ᵢ and c′ᵢ parts.

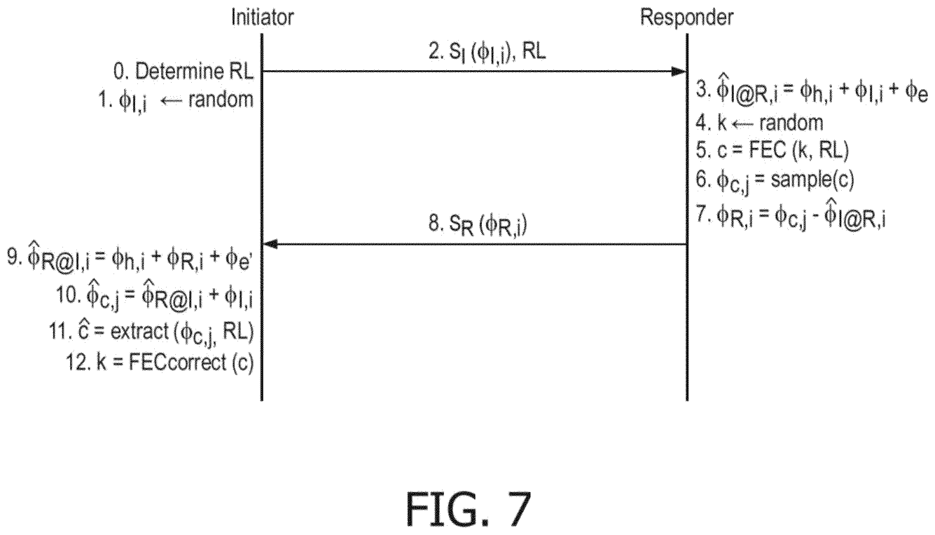

Optionally, in the aforementioned embodiment variants, the initiator may determine a required reliability level (RL) in a prior Step 0 and signals it in Step 2 along with the request message. In steps 5 and 11, a different FEC may be applied based on the received RL, as shown on FIG. 7.

This embodiment, and other embodiments described further, may also apply to other schemes used for key establishment at physical layer. Further options may be used in combination with these embodiments:
Using multiple carriers to exchange a single key bit (to increase reliability).

As in FIG. 4 enhanced as follows:
In step 5, each key bit j encoded in mapped to multiple carriers i.
In step 6, multiple carriers carry information about a single key bit
In step 10, the extract function uses phase information of multiple carriers to reconstruct a single key bit.

Variants of this embodiment, and other embodiments described further, may also be featured by the usage/modification of more than a single physical feature (e.g., phase), i.e., they may usage/modify multiple physical features (e.g., phase and amplitude). This can allow for an increased data rate when securely exchanging or encapsulating data.

### Embodiment 2: Physical Layer Key Encapsulation Integrated in 5G Initial Access Procedure

In a second embodiment, the first embodiment may be adapted to a 5G network and can be used during the link establishment between a UE and gNB. The 5G NR initial access procedure is a form of handshake between the User Equipment (UE) and the base station (gNB) to synchronize DL and UL, grant access to the system, and assign a unique identifier (e.g., C-RNTI) to the UE before the authentication procedure. The following section describes how the proposed key encapsulation scheme can be integrated with 5G NR initial access procedure where the data to be protected corresponds to a random preamble. It may also be integrated in other similar procedures used for the initial establishment of a communication link, e.g., in cellular systems.

The gNB can be defined as the initiator, and the UE as the responder (i.e UE is the party generating the secret key K), the following is defined:
θ_{SS,i}: Random and secret phase of the Synchronization Signal transmitted by gNB.
θ_{SS@UE,i}: Equivalent phase of θ_{SS,i} as estimated by UE with 1 [symbol] i [symbol] N, N being the number of sub-carriers.
θ_{RR,i}: Phases of the random preamble to be transmitted to the gNB.
θ_{P,i}: Random preamble phases after encapsulation (by subtracting θ_{SS@UE,i})
θ_{P@gNB,i}: θ_{P,i} equivalent phases as estimated by gNB.

The NR initial access can be described as follows with reference to FIG. 10: Steps 1 and 2, gNB broadcasts Synchronization Signals (SS) with secret random phases. This refers to the synchronization signals including the MIB and the PCI of the cell. Steps 3 to 5 are similar to the first embodiment, except that instead of generating a random key in step 4, UE selects a random preamble to transmit in the Random Access Channel (RACH); this random preamble is not encoded as usual by means of QAM symbols but is instead used as a payload and encoded into the phases θ_{RP,i}. The signal is then transmitted in step 6.

In step 7, the gNB can estimate the equivalent sub-channels phases similar to the procedure performed by UE in step 3. Then, using the same mechanism described in the first embodiment, gNB unmasks the random preamble phases and finally extracts the random preamble bits. This approach ensures that an eavesdropper cannot access data that is considered to be private.

In another variant, instead of encapsulating the data (e.g., random preamble), an encryption key can be exchanged (e.g., as in one of the embodiments above) between gNB and UE. This key may then be used to encrypt/decrypt the data (e.g., random preamble) that is QAM modulated in the sub-carriers.

Above variants may be combined for instance, a responder may send in the same message an encapsulated key (embodiment 1) and an encrypted or encapsulated data value (previous variant) provided that enough sub-carriers are available. Note that the ratio of sub-carriers allocated for the encrypted data and the encapsulated secret key will vary depending on the secret key size, the number of bits encoded per phase, and the size of encapsulated/encrypted data. Regardless, the current description assumes that both the secret key and data may be transmitted at the same time, and across the available subcarriers.

In another variant based on 5G in Time Division Duplex (TDD) mode, the secret key and encapsulated or encrypted data may be sent separately. That is, initially the secret key is encapsulated and sent to the initiator. Then, the data may be encapsulated, or alternatively encrypted and then sent. On the receiving end, first, the encapsulated key is received, unmasked and decoded as per embodiment 1. Then, a second message containing the data is received. If encrypted, the secret key extracted from the first message is used to decrypt the message (e.g., the demodulated QAM symbols), else, the encapsulated data is unmasked and decoded as per embodiment 1.

In another variant based on 5G, at the transmitter, the bitstream can be enhanced by adding FEC and interleaving the bitstream, bits may then be mapped into modulation symbols, e.g., QAM symbols. Then, chunks of N QAM symbols can be used as input to an IDFT (IFFT) using N different subcarriers. At the receiver, the inverse process can be executed.

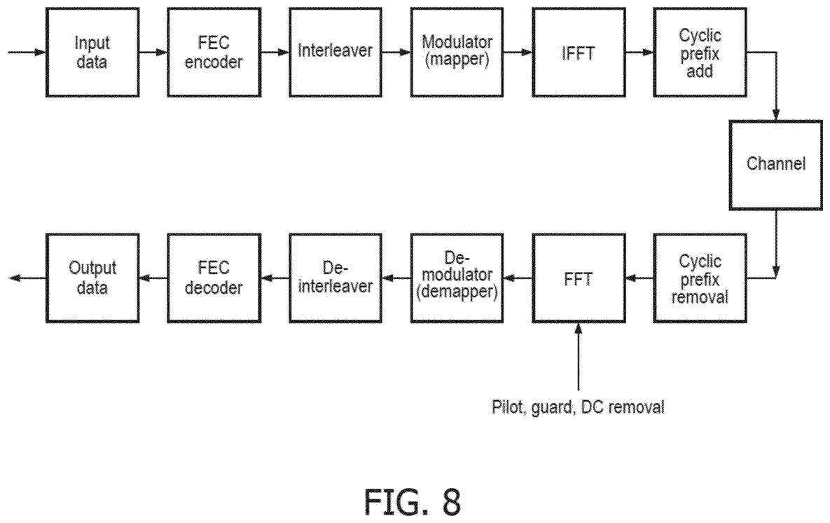

It is to be noted that the following aspects may be combined with any of the other embodiments and might be applicable to other schemes for physical layer security enabling the secure exchange of data or a key:
The probe signal might be created by generating long enough randomized input data. This randomized data is then mapped to (randomized) QAM symbols. If 2^{m}-QAM is used, then the randomized input data might have a length of kₗₑₙ/m bits where kₗₑₙ is the number of bits required for the key+FEC or RBS/CRC as in the first, second, and third embodiments. The FEC or CRC might be additional to the one shown in FIG. 8.
The probe signal might be created by generating a subcarrier, e.g., in the FFT block, with an initial random phase.
In the previous embodiments, Step 3 may be done prior to the cyclic prefix removal, during the synchronization phase for Phase and Frequency Offset correction. Besides, Step 6 (FIG. 4) may be introduced by setting the output of the QAM modulation to the phase in Step 6 or by setting the initial phase of the generated subcarrier to the computed phase.
Furthermore, the magnitude of the vector may be set to its maximum (e.g., in QAM-64) to ensure maximum distance between the resulting constellation points.

In the first embodiments (e.g., corresponding to FIG. 4), steps 8, 9, 10 may be done prior to the cyclic prefix removal, during the synchronization phase for Phase and Frequency Offset correction.

### Embodiment 3: Physical Layer Key Encapsulation Integrated in 5G Sidelink Communications

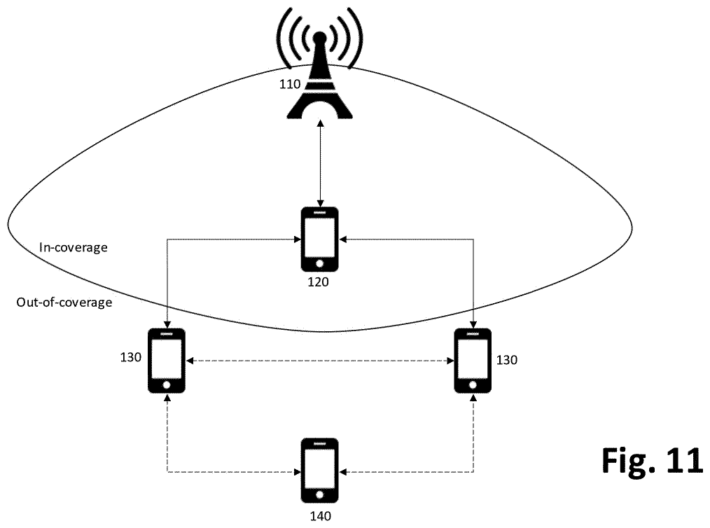

In a third embodiment, and in relation to FIG. 11 where 110 plays the role of a base station (e.g., gNB), 120, a 5G ProSe User-to-Network Relay or an in-coverage UE-to-UE Relay, 130, a couple of 5G ProSe End UEs, and 140 an out-of-coverage 5G ProSe UE-to-UE Relay. The first embodiment may be adapted to 5G Sidelink (or Device-to-device) communications and be used during secure link establishment between 5G ProSe UEs (e.g., between End-UEs and/or End-UEs and Relay-UEs) wherein the initiator and responder may be:
1. Two 5G ProSe UEs trying to establish a direct PC5 communication link (e.g., 130 End-UE₁ and 130 End-UE₂).
2. A 5G ProSe Remote UE and a 5G ProSe UE-to-Network Relay (e.g., 130 End-UE₁ and 120).
3. A 5G ProSe Source End UE and a 5G ProSe UE-to-UE Relay (in the first hop-by-hop link, e.g., 130 End-UE₁ and 140), and a 5G ProSe UE-to-UE Relay and a 5G ProSe Target End UE (in the second hop-by-hop link e.g., 140 and 130 End-UE₂).
4. A 5G ProSe UE-to-UE Relay and one, or multiple, 5G ProSe End UE(s).

In the first scenario, specifically in a 5G ProSe direct discovery procedure based on Model A, and in relation to FIG. 6.1.3.2.2.1-1 in TS 33.503, an Announcing UE may play the role of an initiator, with the monitoring UE playing the role of a Responder. In step 11 of said figure, the announcing UE announces the ProSe Restricted Code; This message may serve as St which the monitoring UE (Responder) may use to encapsulate a payload e.g., randomly generated key K. Following the same steps described in the first, second, or third embodiment, the Responder (i.e., Monitoring UE) may transmit the encapsulated payload e.g., K to the announcing UE and establish a security context based on K and/or keys derived from it e.g., to fallback to in case, e.g., the UEs are not configured with Discovery security materials e.g., DUIK and/or DUSK and/or DUCK. Alternatively, if the monitoring UE is required to perform a Match report procedure for MIC checking, it may only transmit the encapsulated secret key K to the announcing UE if the MIC check is successful.

In the first scenario, specifically in a 5G ProSe direct discovery procedure based on Model B, and in relation to FIG. 6.1.3.2.2.2-1 in TS 33.503, a Discover UE may play the role of an initiator, with the Discoveree UE playing the role of a Responder. In Step 12 of said figure, the discoverer UE sends a Query Code, which may play the role of Si (as described in the first embodiment). Upon processing the Query code in step 13, the Discoveree UE (e.g., Responder) may use the channel phase estimation of the received signal/message to encapsulate a payload e.g., a randomly generated key K, then transmit it along with the Response Code in step 14, or encapsulate the Response Code, or encrypt the Response Code using the randomly generated K, or a key derived from it then transmit it along with the encrypted payload, as described in the second embodiment. The Discoverer UE may then process the received message to retrieve both the secret key K and the Response Code. Previous embodiments related to transmission of a secret key along with data in the same transmission, or separately, may also apply in this scenario.

In the second scenario, where a Remote UE tries to establish a PC5 link with a 5G ProSe UE-to-Network Relay, the second embodiment may be adapted to establish a secret key between the 5G ProSe Remote UE playing the role of the Initiator, and the 5G ProSe UE-to-Network Relay playing the role of a Responder, wherein, the Direct Communication Request or a discovery message may play the role of Si (as described in the first embodiment), and after processing the DCR message or discovery message and performing the necessary checks (e.g., authorization to use UE-to-Network services), the Responder may encapsulate a randomly generated key K and transmit it back to the Remote-UE (i.e., Initiator). Similar to previous embodiment, the encapsulated secret key (or keys derived from it) may be a fallback option to be used to protect the PC5 communication link between Remote-UE and UE-to-Network Relay e.g., if the UEs aren't configured with code sending/receiving security materials (e.g., DUIK, DUSK, and DUCK) and/or lack valid long term credentials.

In the third scenario, where the UEs may be out of 3GPP coverage, the physical layer key encapsulation scheme may provide an alternative to establishing a secure PC5 communication link between the UEs (e.g., End UEs and the UE-to-UE Relay) when e.g., UEs do not have valid long term credentials and/or if UEs lack discovery security materials (e.g., DUIK, DUSK, DUCK).

In an embodiment variant that may be combined with other embodiments or used independently, the key exchanged (in this embodiment variant denoted as KE) by means of the physical layer key encapsulation scheme may not be used standalone but in combination with the discovery security materials. This addresses the following need: (1) ensuring that a higher security level is achieved in case that the security materials (DUIK, DUSK, DUCK) leak or are compromised by an attacker since discovery security materials are usually common to multiple devices. The key KE may be combined with the DUIK, DUSK, or DUCK by using it as input to a cryptographic function (e.g., a key derivation function) used to either derive a final integrity/scrambling/encryption key or the MIC/scrambling/encryption sequence. For instance, the MIC may be computed as the least significant bits of the output of the key derivation function that takes as input the DUIK, the message to be integrity protected, a UTC based counter, and KE. In this example, this ensures that an outsider (that is not at least in the link) does not interfere with the communication.

In a related embodiment variant that may be combined with other embodiments or used independently, the key exchanged (in this embodiment variant denoted as KE) by means of the physical layer key encapsulation scheme may not be used standalone but in combination with the discovery security materials or other established keys, e.g., symmetric keys, on demand when those established keys are used for, e.g., integrity protection, confidentiality protection, or scrambling. For instance, KE may be used as input in the generation of a MIC where the MIC is generated from a pre-established or pre-configured integrity key Kinc. For instance, as KDF(Kinc, message | KE) where KDF(a,b) refers to the key derivation function (KDF) of b taking a as the input cryptographic function where the KDF may be e.g., HMAC-SHA256 and where a|b refers to the concatenation of a and b. Whether KE is used or not at a specific point of time or for a specific message or how KE is obtained (e.g., which physical features, e.g., carriers, or which parameters are used to determine KE) may be determined by the communicating devices, A and B, or a third device. This determination may be performed at random using a secure random generation procedure. When KE is to be used is to be exchanged between A and B, configured by the third device, etc in a secure manner, i.e., in an integrity and protected manner so that an eavesdropper or a man-in-the-middle does not know when KE is used as input in the generation of the MIC or in combination with other established keys. By doing this, the communicating devices A and B can ensure that there is no MitM between them.

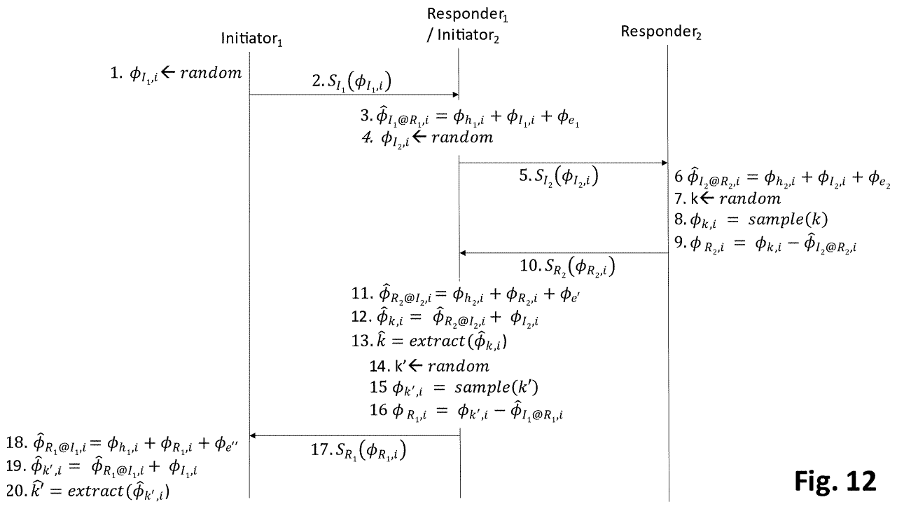

In an embodiment related to the third scenario and to FIG. 12, where a Source End UE plays the role of an Initiator (e.g., Initiator₁), the UE-to-UE Relay plays the role of both a Responder and an Initiator (Responder₁ in the first hop-by-hop link and Initiator₂ in the second hop-by-hop link), and a Target End UE plays the role of a Responder (e.g., Responder₂), the first embodiment may be adapted to establish secret keys and/or exchange or relay a payload, based on Physical Layer Key Encapsulation, for both hop-by-hop links, wherein:
Steps 1, 2, and 3, and 4,5, and 6 are similar to the initial steps in the first embodiment.
Steps 7, 8, 9, and 10 where Responder₂ (i.e., Target-UE) encapsulates and transmits a randomly generated key to Initiator₂/Responder₁ (i.e., UE-to-UE Relay).
Steps 11, 12, and 13 where the UE-to-UE Relay decapsulates and extracts the payload e.g., secret key transmitted by Target-UE. This key (e.g, K), and/or keys derived from it may be used, as described in previous embodiments (e.g., as a fallback option if other security materials are lacking/not provisioned) to protect the second hop-by-hop link.
Steps 14, 15, 16, and 17 (similar to steps 7,8,9, and 10) where the UE-to-UE Relay encapsulates and transmits a payload e.g., randomly generated key to Initiator₁ (i.e., Source-UE)
Steps 18, 19, and 20 (similar to steps 11, 12, and 13) where the Source-UE decapsulates and extracts the payload e.g., secret key K′. This key (e.g., K′) and/or keys derived from it may be used to protect the first hop-by-hop link.

It is to be noted, that the steps, as defined in FIG. 12, may be performed in a different order, skipped, and/or replayed. For instance, and as a variant of this embodiment, step 14 may be skipped, and instead, UE-to-UE Relay extract the payload (e.g., data/secret key transmitted by the Target-UE), encapsulates it and transmits it to Source-UE. As such, the payload e.g., secret key, and/or keys derived from it, may serve as the basis for securing both hop-by-hop links.

In another embodiment variant, step 17 may be performed at an earlier stage (e.g., before step 10), to establish a secret key ensuring the security of the first hop-by-hop link, independently of the exchange in the second hop-by-hop link.

In another embodiment variant that may be combined with other embodiments, the scheme proposed may not only be used to establish secret keys, but also to encapsulate data (e.g., RSC, or PRUK-ID) that is communicated to another UE (e.g., UE-to-UE or UE-to-Network Relay) and that requires protection. For instance, in case code sending/receiving security materials are not provisioned at a Remote UE, Physical Layer Key Encapsulation may provide an alternative to protect the RSC and PRUK-ID in a Remote-UE to UE-to-Network link establishment scenario.

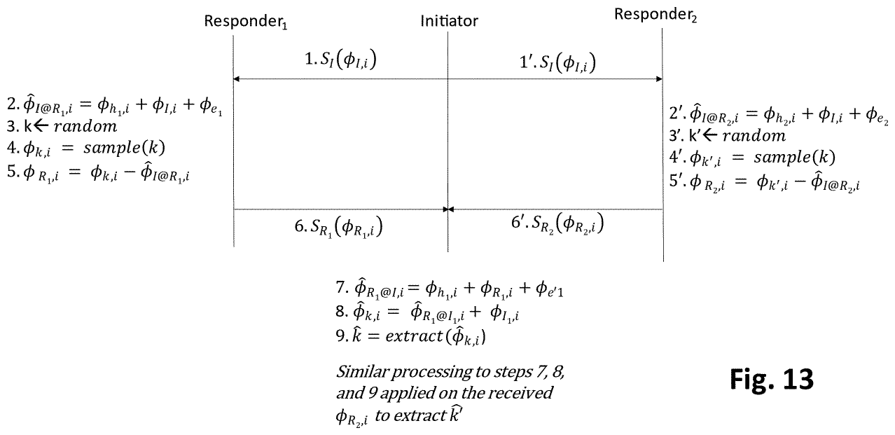

In the fourth scenario, and in relation to FIG. 13, End UEs that may lack valid discovery security materials and/or long term credentials may rely on Announcement messages (playing the role of Sᵢ as described in the first embodiment) broadcasted by a UE-to-UE Relay (playing the role of an Initiator) e.g., steps 1 and 1′ in FIG. 13, to encapsulate randomly generated keys (e.g., k and k′ generated in steps 3 and 3′, and encapsulated in steps 5 and 5′) and communicate them (e.g., as in steps 6/6′ of FIG. 13) to the UE-to-UE Relay. The UE-to-UE Relay processes the received response signals from steps 6 and 6′ as described in above embodiments to extract the payloads (e.g., k and k′ in this example). k and k′ (or keys derived from them) may subsequently be used to protect the PC5 communication link between the End UEs and the UE-to-UE Relay.

In an embodiment variant related to the fourth scenario, the UE-to-UE Relay may periodically broadcast announcement messages (e.g., every T seconds), and process Response signals received from ProSe End UEs within that time window to establish secret keys with the End UEs. This has the advantage that with a single broadcasted signal/announcement message, several secret keys may be established to protect multiple sidelink, PC5 communication links.

In an embodiment variant that may be combined with other embodiments or used independently, instead of a discovery and/or a direct communication message, where applicable, if an initiator UE (e.g., Discoverer-UE, or Announcing-UE) transmits Sidelink Synchronization Signals (e.g., Sidelink Primary Synchronization Signal (S-PSS) and Sidelink Secondary Synchronization Signal (S-SSS), the Responder-UE (e.g., Monitoring-UE, or Discoverer-UE) may use these signals as S₁, as described in the first embodiment, to encapsulate the payload (e.g., data, secret key) and respond to the Initiator UE. This has the advantage of establishing a security key (e.g., when the payload is a secret key) before or during the initial discovery or direct communication message is transmitted, thus providing a means to secure such messages, by being combined with provisioned discovery security materials and/or long term credentials, and/or provide a fallback option in case these upper layer security materials have not been provisioned to the UEs, or have expired.

These embodiments may be combined with other enhancing techniques of physical layer key encapsulation e.g., FEC, CRC/RBS or used independently.

### Embodiment 4: Collocated Resource Allocation

In FIG. 4, steps 2 and 7 need to be performed using the same sub-carriers and within a limited amount of time such that the channel between Initiator and Responder does not change. Furthermore, the processing of the messages in these steps may be slightly different than the processing of messages that do not involve key encapsulation, thus:
In FIG. 4, step 2 may perform implicit resource allocation for Step 7. In other words, an initiator device transmitting a message in Step 2 may implicitly indicate to a receiving device which frequency sub-carriers to use in/for the reply message.
A resource allocation message may be transmitted to the responder (and optionally to the initiator) before Steps 2 and 7 indicating the allocated resources for both Steps 2 and 7.
A resource allocation message may be transmitted to the responder (and optionally to the initiator) before Steps 2 and 7 indicating that messages processed in Steps 2 and 7 might require the usage of the last embodiments (extending the normal processing of physical layer messages in FIG. 5).

In all the previous embodiments, it is possible to improve the transmission and retrieve a secret message and a message. To do so, the signal transmitted by responder in step 7 (e.g., in FIG. 4) which contains the secret key in its phases is sufficient to retrieve the secret key and the content of the signal transmitted. This is applicable, e.g., to the previous embodiment used to protect the initial 5G PRACH message.

In an embodiment related to the second embodiment, the message constructed by the UE in Step 6 and sent in Step 7 is constructed as in Embodiment 1. The θ_{K,i}−θ_{SS@EU,i} value is used to adjust the initial phase of subcarrier i and the data is encoded in the subcarrier i. At step 8, the gNB can measure the phase of subcarrier i when the signal is first received extracting the key as in Embodiment 1. Then the data symbols can be retrieved from the subcarriers.

In another embodiment related to the previous embodiment, the extracted key is used to correct the phase offset of the received subcarrier.

In another embodiment, to enable the Initiator to retrieve both the secret key and the data:
Responder encapsulates a secret key
Responder encapsulates the data or encrypts it before modulating it, e.g., in QAM symbols, then transmits a signal containing the encapsulated secret key and data. o Initiator receives signal
   Initiator retrieves the secret key phases (e.g. FIG. 4 steps 9 and 10) and/or
   Initiator retrieves the data (e.g., FIG. 10 steps 8 and 9 (if the data was encapsulated), or decrypts the data after demodulation (if the data was encrypted).

In a third embodiment of the invention, a similar protocol is applied to other schemes used for key establishment at the physical layer. It can thus provide 1-way encryption as follows:

First, the Responder receives a probe signal,

Then, the Responder generates a key, and an answer message.

The responder can use the key to encrypt chosen fields in the answer message. For example, the responder can use the key at application layer or at L2 layer, or at L1 layer with a standard encryption algorithm e.g. AES in stream cipher mode (using, e.g., counter mode).

Then, the Responder may encode and encapsulate the key into the phases of the subcarriers, add encrypted message (e.g., modulated as QAM symbols) and construct the signal as explained earlier.

Finally, at the Initiator side, the Initiator receives the signal, retrieves the secret key from the sub-carriers' phases. The Initiator then uses the retrieved key to decrypt the chosen encrypted fields of the message.

### Embodiment 5: Application to Ambient IoT Tags

In the above embodiments, it has been described how physical layer security can be used to protect data exchanged between an initiator and a responder. Such procedures may be of particular interest in ambient IoT scenarios as described in TR 22.840 wherein a UE or an access device may play the role of an initiator and the responder may be resource constrained devices such as ambient IoT tags. The IoT tags may protect information to be exchanged as disclosed in other embodiments. This can lead to a simpler design of ambient IoT tags where expensive functionality may not be required.

In an embodiment, an IoT tag may receive a request from an initiator requiring the retrieval of data. The IoT tag may determine information to be exchanged (e.g., a key or data itself) and encode/encapsulate it in the response message, e.g., in the initial phases of the OFDM carriers when an OFDM modulation is used so that the initiator can securely retrieve the information.

In the examples in the above embodiments, the initiator/responder roles may be taken by different types of wireless devices, e.g., a UE, an access device such as a gNB, a relay (UE-to-UE or UE-to-Network Relay), and the responder may be taken by either one of the previously mentioned entities, or an (ambient) IoT tag.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. The foregoing description details certain embodiments of the invention. It will be appreciated, however, that no matter how detailed the foregoing appears in the text, the invention may be practiced in many ways, and is therefore not limited to the embodiments disclosed. It should be noted that the use of particular terminology when describing certain features or aspects of the invention should not be taken to imply that the terminology is being re-defined herein to be restricted to include any specific characteristics of the features or aspects of the invention with which that terminology is associated.

A single unit or device may fulfill the functions of several items recited in the claims. The mere fact that certain measures are recited in mutually different dependent claims does not indicate that a combination of these measures cannot be used to advantage.

The described operations can be implemented as program code means of a computer program and/or as dedicated hardware of the related communication device or access device, respectively. The computer program may be stored and/or distributed on a suitable medium, such as an optical storage medium or a solid-state medium, supplied together with or as part of other hardware, but may also be distributed in other forms, such as via the Internet or other wired or wireless telecommunication systems.

1. A method comprising:
receiving an initiation message from an initiator;
measuring at least one incoming physical characteristic of the initiation message;
creating a response message;
modifying at least one physical characteristic of the response message based on a combination of the at least one incoming physical characteristic and the payload; and
transmitting the modified response message to an initiator.

2. The method of claim 1, wherein the combination of incoming physical signal characteristic and the payload comprises:
encoding the payload as a codeword,
wherein the codeword comprises a set of bits,
wherein the set of bits is a mapped set of physical characteristic values,
generating the combination as a difference between the measured incoming physical signal characteristic and the mapped set of physical characteristic values.

3. The method of claim 1,
wherein the payload is an encryption key,
wherein the encryption key is used by the initiator for secure communication.

4. The method of claim 1, wherein the at least one physical characteristic of the initiation message and the at least one physical characteristic of the response message comprises:
a phase;
a phase difference for each carrier relative to a reference carrier;
a gain;
a gain difference for each carrier relative to a reference carrier;
a polarization for each beam relative to a reference beam;
modulation symbols;
a gain value applied to each beam respectively;
an Operation, Administration, Maintenance mode;
a phase pattern in an Operation, Administration, Maintenance mode; and
a sense of polarization.

5. The method of claim 1, wherein the payload comprises:
at least one set of parity check bits;
at least one set of Cyclic Redundancy Check bits; and
a reliability bit-string known by the initiator.

6. The method of claim 1, wherein the payload is obtained by applying a Forward Error Correction algorithm to a set of information bits.

7. The method of claim 1, wherein the payload is obtained by interleaving a set of information bits with at least one of a corresponding reliability bit-string known by the initiator, or a set of parity check bits or a cyclic redundancy check.

8. The method of claim 1, wherein the initiator is an End device and/or a Relay communicating using at least one sidelink communication link.

9. The method of claim 1, wherein the initiator is a User Equipment or an access device.

10. The method of claim 1, further comprising acting as a second initiator that exchanges a payload with a second responder, wherein the second initiation uses a separate communication link.

11. The method of claim 1, wherein an established secret key is used when discovery security materials are not provided and/or have expired long-term credentials.

12. The method of claim 1,
wherein, an established secret key is combined with established or provisioned security materials to derive a cryptographic key or a Message Integrity Code or a scrambling sequence or an encryption sequence using cryptographic function,
wherein the cryptographic function may be a key derivation function, or an encryption algorithm or an integrity algorithm.

13. A method comprising:
generating an initiation message;
performing a first modification of at least physical characteristic of the initiation message;
transmitting the modified initiation message to a responder;
wherein a responder receives the modified initiation message,
wherein the responder measures at least one incoming physical characteristic of the modified initiation message,
wherein the responder creates a response message,
wherein the responder modifies at least one physical characteristic of the response message on the basis of a second modification using a combination of the measured incoming physical characteristic and the payload,
wherein the responder transmits the modified response message to the initiator;
receiving the modified response message;
modifying the modified response message based on the basis of the first modification; and
extracting the payload from the modified response message.

14. The method of claim 13, wherein the combination of incoming physical signal characteristic and the payload comprises:
encoding the payload as a codeword,
wherein the codeword comprises a set of bits,
wherein the set of bits is a mapped set of physical characteristic values,
generating the combination as a difference between the measured incoming physical signal characteristic and the mapped set of physical characteristic values.

15. The method of any of claim 13,
wherein the payload is an encryption key,
wherein the encryption key is used by the initiator for secure communication.

16. The method of any of claim 13, wherein the first modification is a random change of the at least one physical characteristic of the initiation message.

17. The method of claim 13, wherein the at least one physical characteristic of the initiation message and the at least one physical characteristic of the response message comprises:
a phase;
a phase difference for each carrier relative to a reference carrier;
a gain;
a gain difference for each carrier relative to a reference carrier;
a polarization for each beam relative to a reference beam;
modulation symbols;
a gain value applied to each beam respectively;
an Operation, Administration, Maintenance mode;
a phase pattern in an Operation, Administration, Maintenance mode; and
a sense of polarization.

18. The method of claim 13, wherein the payload comprises:
at least one set of parity check bits;
at least one set of Cyclic Redundancy Check bits; and
a reliability bit-string known by the initiator.

19. The method of claim 13, wherein the payload is obtained by applying a Forward Error Correction algorithm to a set of information bits.

20. The method of claim 13, wherein the payload is obtained by interleaving a set of information bits with a corresponding reliability bit-string known by the initiator.

21. The method of claim 13, wherein the payload comprises:
an encapsulated key; and
a random preamble, wherein the random preamble is selected by the responder.

22. The method of claim 13, wherein the responder is an End device and/or a Relay communicating using at least one sidelink communication link.

23. (canceled)

24. The method of claim 13, wherein the responder is a passive/ambient IoT device.

25. The method of claim 13, further comprising acting as a second initiator that exchanges a payload with a second responder, wherein the second initiation uses a separate communication link.

26. The method of claim 13, wherein an established secret key is used when discovery security materials are not provided and/or have expired long-term credentials.

27. The method of claim 13,
wherein, an established secret key is combined with established or provisioned security materials to derive a cryptographic key or a Message Integrity Code or a scrambling sequence or an encryption sequence using a cryptographic function,
wherein the cryptographic function may be a key derivation function, or an encryption algorithm or an integrity algorithm.

28. A comprising:
generating an initiation message;
performing a first modification of at least one physical characteristics of the initiation message;
transmitting the modified initiation message to a responder;
receiving a response message;
modifying the response message based on the first modification; and
extracting a payload from the modified response message.

29. The method of claim 28, further comprising using an encryption key to decrypt the data transmitted in the received message, wherein the payload corresponds to an encryption key.

30. The method of claim 28, wherein the responder is an End device and/or a Relay communicating using at least one sidelink communication link.

31. The method of claim 28, wherein the responder is a passive/ambient IoT device.

32. The method of claim 28, further comprising acting as a second initiator that exchanges a payload with a second responder, wherein the second initiation uses a separate communication link.

33. The method of claim 28, wherein an established secret key is used when discovery security materials are not provided and/or have expired long-term credentials.

34. The method of claim 28,
wherein, an established secret key is combined with established or provisioned security materials to derive a cryptographic key or a Message Integrity Code or a scrambling sequence or an encryption sequence using a cryptographic function,
wherein the cryptographic function may be a key derivation function, or an encryption algorithm or an integrity algorithm.

35. (canceled)

36. A communication apparatus comprising:
a controller circuit and a memory circuit, wherein the memory is arranged to store instructions for the processor circuit;
a receiver circuit;
a transmitter circuit;
wherein the receiver circuit is arranged to receive an initiation message from an initiator,
wherein the controller circuit is arranged to to measure at least one incoming physical characteristic of the received initiation message,
wherein the controller circuit is arranged to create a response message,
wherein the controller circuit is arranged to modify at least one physical characteristic of the response message based on a combination of the at least one incoming physical characteristic and the payload,
wherein the transmitter circuit is arranged to transmit the modified response message to the initiator.

37. A communication comprising:
a controller circuit and a memory circuit, wherein the memory is arranged to store instructions for the processor circuit;
a transmitter circuit;
a receiver circuit;
wherein the controller circuit is arranged to generate an initiation message,
wherein the controller circuit is arranged to perform a first modification of at least one physical characteristic of the initiation message,
wherein the transmitter circuit is arranged to transmit the modified initiation message to a responder,
wherein the receiver circuit is arranged to receive a modified response message,
wherein the controller circuit is arranged to modify the modified response message based on the first modification,
wherein the controller circuit is arranged to extract the payload from the modified response message.

38. (canceled)

39. (canceled)

40. A computer program stored on a non-transitory medium, wherein the computer program when executed on a processor performs the method as claimed in claim 1.

41. A computer program stored on a non-transitory medium, wherein the computer program when executed on a processor performs the method as claimed in claim 13.

42. A computer program stored on a non-transitory medium, wherein the computer program when executed on a processor performs the method as claimed in claim 28.
